(19) United States
(12) Patent Application Publication
(10) Pub. No.: US 2019/0060687 A1
(43) Pub. Date: Feb. 28, 2019

(54) BATTERY POWERED ELECTRIC MOTOR-DRIVEN FIRE PUMP SYSTEM AND METHOD

(71) Applicant: TORNATECH INC., Laval (CA)

(72) Inventors: BRUNO GOUPIL, LAVAL (CA); BENOIT LORRAIN, LAVAL (CA); MARC GOUPIL, LAVAL (CA)

(21) Appl. No.: 16/103,956

(22) Filed: Aug. 16, 2018

Related U.S. Application Data
(60) Provisional application No. 62/546,243, filed on Aug. 16, 2017.

(51) Int. Cl. A62C 31/00; A62C 37/00

(52) U.S. Cl. CPC A62C 31/00; A62C 37/00

(57) ABSTRACT

Battery powered electric motor-driven fire pump system for maintaining water pressure in a fire sprinkler network. The fire pump system includes: a fire pump controller including a fire pump controller logic, a battery charger and a plurality of starting contactors; a battery pack connected to the battery charger and to the plurality of starting contactors, the battery pack rechargeable by the battery charger; an electric motor powered by the battery pack through the plurality of starting contactors; and a fire pump drivable by the electric motor. In use, when the fire pump controller detects a drop in water pressure in the fire sprinkler network, the fire pump controller activates the electric motor to drive the fire pump to restore water pressure in the fire sprinkler network.

### CROSS REFERENCE TO RELATED APPLICATIONS

This application claims benefit, under 35 U.S.C. § 119(e), of U.S. provisional application Ser. No. 62/546,243, filed on Aug. 16, 2017, which is incorporated herein in its entirety by reference.

### TECHNICAL FIELD

The present disclosure concerns a battery powered driver for a fire pump motor. Specifically, the present disclosure concerns a high efficiency battery powered electric motor-driven fire pump.

### BACKGROUND OF THE INVENTION

Fire pumps are needed when local municipal water systems, for example public underground water supplies, tanks, reservoirs and lakes, cannot provide sufficient pressure to meet the hydraulic design requirements of a fire sprinkler system. This usually occurs if a budding is very tall, or if the system requires a relatively high terminal pressure at the fire sprinklers in order to provide large volumes of water, such as in storage warehouses. Fire pumps are also needed when the water supply is provided by a ground level water storage tank.

When the sprinkler system activates, a pressure sensor in the water line detects a drop in water pressure, and then signals the fire pump controller to activate the fire pump to provide the sprinkler system with sufficient water pressure. Currently, two major types of systems are used as a power source for stationary fire sprinkler pump installations: alternating current (AC) electric motor-driven fire pumps and diesel engine-driven fire pumps.

In an AC electric motor-driven fire pump system, electricity from a dedicated electrical service entrance from the utility grid acts as the main source of energy, which must be a three-phase power source. A secondary source of energy is normally provided by a second utility connection or by a generator set. When a generator set or a second utility is provided, a dedicated automatic transfer switch (ATS) must be connected to the fire pump controller to select the source of energy. These types of fire pump systems are quite expensive due to the requirement of one or two dedicated power service entrances with 2-hour fire rated wiring and sufficient capacity to start the electric motor. Further, if the secondary source of energy is provided by a generator set, this generator set must be oversized to accommodate the fire pump motor load. In addition, the operating costs are quite high due to the premium that must be paid for electricity consumption when the system starts, as a high inrush of electric current is initially required.

In a diesel engine-driven fire pump system, diesel fuel acts as the main source of energy. The system requires two start batteries (each with an associated battery charger) that are used to alternatively crank the diesel engine starter when the engine is called on to start. As the pump is driven strictly by the diesel engine, the system does not require electrical power in order to function and is thus readily available in case of power failure. However, in case of fire in the absence of electrical power, the batteries must be oversized in order to be able to start the diesel engine for a period of no less than 96 hours. Further, a diesel engine installation is quite expensive as it requires a separate pump room, two high amperage capacity batteries, two battery chargers capable of fully charging the batteries within 24 hours, a diesel fuel tank with a minimum of two hours' worth of fuel reserve, an exhaust system piped to the outside of the pump room, a cooling system with a heat exchanger, and a ventilation system. In addition, diesel engine installations require constant and expensive maintenance, such as oil, oil filter and cooling fluid changes, battery replacements, and more. Additionally, diesel-based systems occupy a relatively large footprint due to the plethora of components and they produce a high level of noise and vibration.

There is thus a need for a fire pump system powered by a source of energy that is cheaper, independent of the electrical network grid or fuel, easier to maintain and more reliable.

### SUMMARY OF THE INVENTION

In order to address the above and other drawbacks, there is provided a battery powered electric motor-driven fire pump system for maintaining water pressure in a fire sprinkler network, the fire pump system comprising a fire pump controller comprising a fire pump controller logic, a battery charger and a plurality of starting contactors, a battery pack connected to the battery charger and to the plurality of starting contactors, the battery pack rechargeable by the battery charger, an electric motor powered by the battery pack through the plurality of starting contactors, and a fire pump drivable by the electric motor, wherein when the fire pump controller detects a drop in water pressure in the fire sprinkler network, the fire pump controller activates the electric motor to drive the fire pump to restore water pressure in the fire sprinkler network.

In an embodiment, the drop in water pressure in the fire sprinkler network is detected via a dedicated pressure sensing line, the pressure sensing line notifying the fire pump controller of the drop in water pressure.

In an embodiment, the battery pack has enough capacity for at least two hours of reserve power.

In an embodiment, the electric motor is an alternating current electric motor.

In an embodiment, the electric motor is a direct current electric motor.

In an embodiment, the battery pack's voltage is monitored by the fire pump controller logic.

There is also provided a method for uninterruptedly powering a fire pump system for maintaining water pressure in a fire sprinkler network, the method comprising the steps of maintaining the electric charge in a battery pack connected to a battery charger and a plurality of starting contactors, alerting a fire pump controller comprising a fire pump controller logic, the battery charger and the plurality of starting contactors when the water pressure in the fire sprinkler network drops, and activating an electric motor powered by the battery pack through the plurality of starting contactors to drive a fire pump to restore water pressure in the fire sprinkler network.

All of the foregoing and still further objects and advantages of the invention will become apparent from a study of the following specification, taken in connection with the accompanying drawings wherein like characters of reference designate corresponding parts throughout the several views.

### BRIEF DESCRIPTION OF THE FIGURES

Embodiments of the disclosure will be described by way of examples only with reference to the accompanying drawing, in which:

FIG. 1 is a schematic diagram of a typical AC electric motor-driven fire pump system;

FIG. 2 is a schematic diagram of a typical diesel engine-driven fire pump system; and

FIG. 3 is a schematic diagram of a battery powered electric motor-driven fire pump system, in accordance with an illustrative embodiment of the present invention.

### DETAILED DESCRIPTION

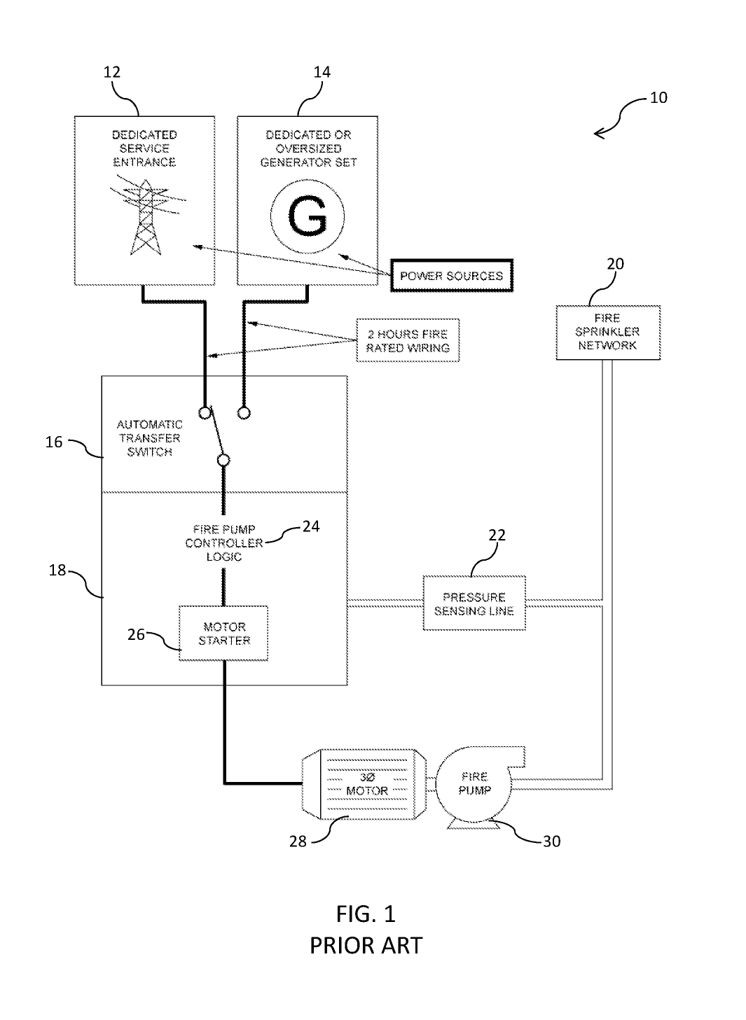

Referring to FIG. 1, there is shown a schematic diagram of a typical AC electric motor-driven fire pump system, generally referred to by the reference numeral 10. Electricity from the building electricity supply 12 entering from a dedicated service entrance acts as the main source of energy for the system 10. A secondary source of energy may be provided by a dedicated or oversized generator set 14. When such a dedicated or oversized generator set 14 is provided, a dedicated automatic transfer switch (ATS) 16 must be connected to the fire pump controller 18 for selecting the source of energy. Under normal operations, the fire pump controller 18 monitors the water pressure from the fire sprinkler network 20 through data sent from a pressure sensing line 22 to the fire pump controller logic 24. In the case of a fire, the pressure sensing line 22 detects a drop in the water pressure in the fire sprinkler network 20 and notifies the fire pump controller 18. The fire pump controller 18 then engages the motor starter 26 which starts an alternating current (AC) electric motor 28 which drives a fire pump 30, thus raising the water pressure in the fire sprinkler network 20.

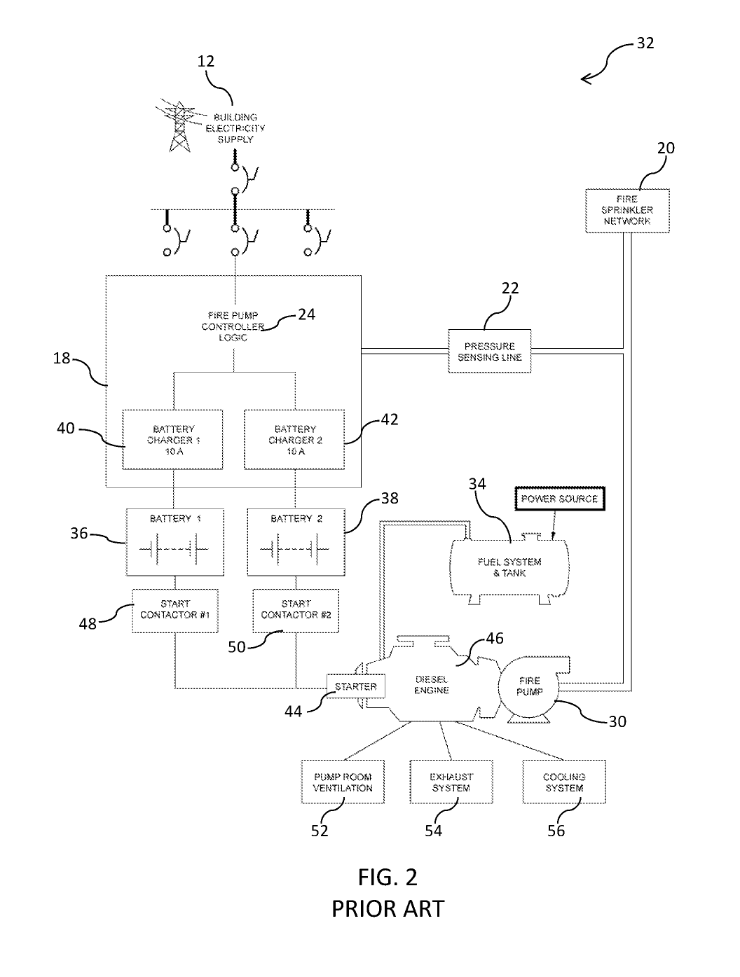

Referring now to FIG. 2, there is shown a schematic diagram of a typical diesel engine-driven fire pump system, generally referred to by the reference numeral 32. Diesel fuel stored in a fuel system and tank 34 acts as the main source of energy for the system 32. As in the AC electric motor-driven fire pump system 10 of FIG. 1, the fire pump controller 18 monitors the water pressure in the fire sprinkler network 20 through the pressure sensing line 22. In addition, the fire pump controller 18 monitors the voltage of two start batteries 36, 38 and two battery chargers 40 and 42. In the case of a fire, the pressure sensing line 22 detects a drop in the water pressure in the fire sprinkler network 20 and notifies the fire pump controller 18. The fire pump controller 18 then triggers the batteries 36, 38 to alternatively crank an engine starter 44 for a diesel engine 46 to power the fire pump. The electric charges in batteries 36, 38 are maintained by the building electricity supply 12. The diesel engine 46 is connected to a pump room ventilation 52, exhaust system 54 and cooling system 56.

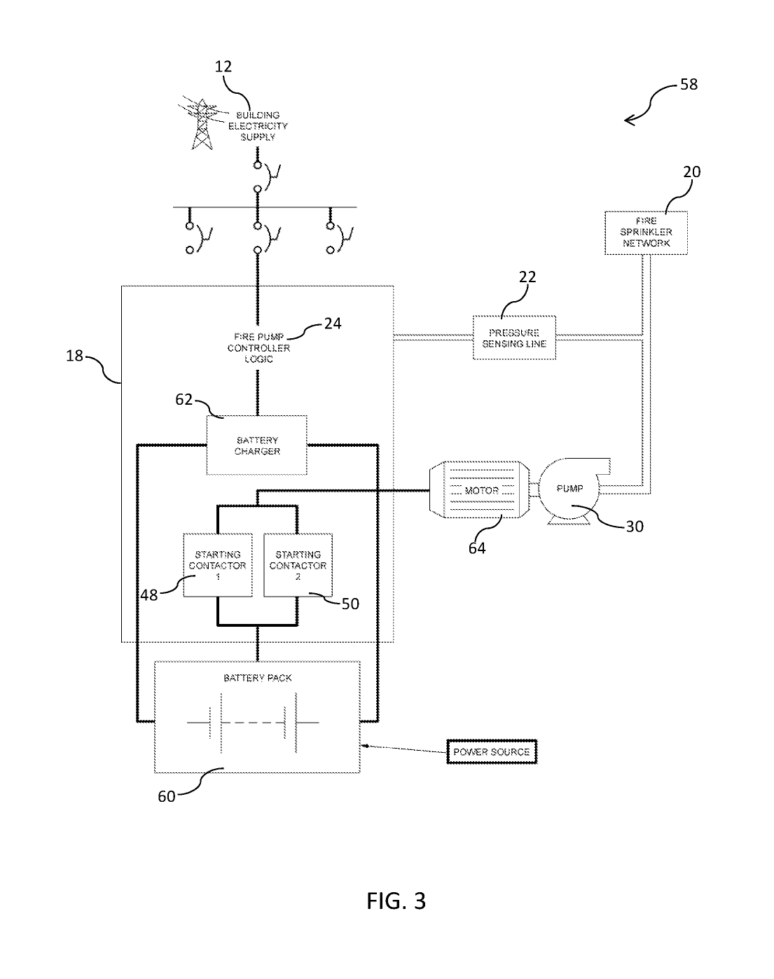

Referring now to FIG. 3, there is shown a schematic diagram of a battery powered electric motor-driven fire pump system, generally referred to by the reference numeral 58, in accordance with an illustrative embodiment of the present invention. A high efficiency battery pack 60 acts as the main source of energy for the system 58. A battery charger 62, connected to the building electric supply 12 and controlled by the fire pump controller logic 24, constantly ensures that the high efficiency battery pack 60 is fully charged. The high efficiency battery pack 60's voltage is monitored by the fire pump controller logic 24 as well. As in the AC electric motor-driven fire pump system 10 of FIG. 1 and the diesel engine-driven fire pump system 32 of FIG. 2, the fire pump controller 18 monitors the water pressure in the fire sprinkler network 20 through the pressure sensor line 22. If a fire is detected, the fire pump controller 18 detects a drop in water pressure in the fire sprinkler network 20, triggers an electric motor 64, illustratively an AC electric motor or a direct current (DC) electric motor, to run the fire pump 30. The fire pump 30 remains activated until water pressure in the fire sprinkler network 20 is sufficiently built up.

Still referring to FIG. 3, in an embodiment, the system 58 comprises two starting contactors 48 and 50 connected to the high efficiency battery pack 60 to ensure operational redundancy. In another embodiment, the high efficiency battery pack 60 has a minimum reserve of 2 hours in case of fire. Thus, the system 60 operates independently of the building electricity supply 12 or of any fuel. As such, the system 60 is ready to operate even in the case of a power outage, as there is sufficient energy stored in the high efficiency battery pack 60. Further, as the system 58 requires no fuel, there are no emissions produced during its operation.

The scope of the claims should not be limited by the preferred embodiments set forth in the examples, but should be given the broadest interpretation consistent with the description as a whole.

1. A battery powered electric motor-driven fire pump system (58) for maintaining water pressure in a fire sprinkler network (20), the fire pump system (58) comprising:
a fire pump controller (18) comprising a fire pump controller logic (24), a battery charger (62) and a plurality of starting contactors (48, 50);
a battery pack (60) connected to said battery charger (62) and to said plurality of starting contactors (48, 50), said battery pack (60) rechargeable by said battery charger (62);
an electric motor (64) powered by said battery pack (60) through said plurality of starting contactors (48, 50); and
a fire pump (30) drivable by said electric motor (64);
wherein when said fire pump controller (18) detects a drop in water pressure in the fire sprinkler network (20), said fire pump controller (18) activates said electric motor (64) to drive said fire pump (30) to restore water pressure in the fire sprinkler network (20).

2. The battery powered electric motor-driven fire pump system of claim 1, wherein said drop in water pressure in the fire sprinkler network (20) is detected via a dedicated pressure sensing line (22), said pressure sensing line (22) notifying said fire pump controller (18) of said drop in water pressure.

3. The battery powered electric motor-driven fire pump system of claim 1, wherein said battery pack (60) has enough capacity for at least two hours of reserve power.

4. The battery powered electric motor-driven fire pump system of claim 1, wherein said electric motor (64) is an alternating current electric motor.

5. The battery powered electric motor-driven fire pump system of claim 1, wherein said electric motor (64) is a direct current electric motor.

6. The battery powered electric motor-driven fire pump system of claim 1, wherein a voltage of said battery pack (60) is monitored by said fuel pump controller logic (24).

7. A method for uninterruptedly powering a fire pump system (58) for maintaining water pressure in a fire sprinkler network (20), said method comprising the steps of:
maintaining the electric charge in a battery pack (60) connected to a battery charger (62) and a plurality of starting contactors (48, 50);
alerting a fire pump controller (18) comprising a fire pump controller logic (24), said battery charger (62) and said plurality of starting contactors (48, 50) when the water pressure in the fire sprinkler network (20) drops; and
activating an electric motor (64) powered by said battery pack (60) through said plurality of starting contactors (48, 50) to drive a fire pump (30) to restore water pressure in the fire sprinkler network (20).
